(19) United States
(12) Patent Application Publication
(10) Pub. No.: US 2025/0112584 A1
(43) Pub. Date: Apr. 3, 2025

(54) PHOTOVOLTAIC DEVICE AND METHOD FOR MOUNTING PHOTOVOLTAIC DEVICE

(71) Applicants: JINKO SOLAR CO., LTD., SHANGRAO (CN); ZHEJIANG JINKO SOLAR CO., LTD., HAINING (CN)

(72) Inventors: Sen YANG, SHANGRAO (CN); Zhiliang DENG, SHANGRAO (CN); Bo LI, SHANGRAO (CN); Yi CHENG, SHANGRAO (CN); Tong YU, SHANGRAO (CN); Liangyin ZHAO, SHANGRAO (CN); Xiaomeng GUI, SHANGRAO (CN); Fei YANG, SHANGRAO (CN)

(21) Appl. No.: 18/638,533

(22) Filed: Apr. 17, 2024

(30) Foreign Application Priority Data
Sep. 28, 2023 (CN) 202311278703.6
Sep. 28, 2023 (CN) 202311279037.8
Sep. 28, 2023 (CN) 202322660999.X
Sep. 28, 2023 (CN) 202322663447.4
Sep. 28, 2023 (CN) 202322663945.9

(51) Int. Cl. H02S 20/20

(52) U.S. Cl. CPC H02S 20/20

(57) ABSTRACT

A photovoltaic device and a method for mounting a photovoltaic device are provided. The photovoltaic device includes a color steel tile, a bonding layer, and a photovoltaic assembly. The color steel tile includes an angle relaxation portion. The bonding layer is arranged on a top wall of the angle relaxation portion. The photovoltaic assembly is located on one side of the color steel tile and connected to the color steel tile through the bonding layer. The bonding layer includes a first bonding portion and a second bonding portion arranged along a first direction. In the first direction, a ratio of a dimension of the first bonding portion to a dimension of the second bonding portion ranges from 0.1 to 0.5. The first bonding portion temporarily fix the photovoltaic assembly, while the second bonding portion mainly fix the photovoltaic assembly.

### CROSS-REFERENCE TO RELATED APPLICATIONS

The present application claims priority to Chinese Application No. 202322660999.X, Chinese Application No. 202311278703.6, Chinese Application No. 202322663945.9, Chinese Application No. 202322663447.4, and Chinese Application No. 202311279037.8, which are filed on Sep. 28, 2023, the contents of which are incorporated herein by reference in their entireties.

### TECHNICAL FIELD

The present disclosure relates to the technical field of photovoltaic cells, and in particular, to a photovoltaic device and a method for mounting a photovoltaic device.

### BACKGROUND

A photovoltaic device can convert received solar energy into electrical energy, which may be applied to buildings such as production plants and warehouses. In an existing photovoltaic device, stability and reliability of mounting of a photovoltaic assembly on a color steel tile are low, and the photovoltaic assembly is prone to movement relative to the color steel tile, or easily falls off from the color steel tile, which may affect stable operation of the entire photovoltaic device.

### SUMMARY

In view of the above, the present disclosure provides a photovoltaic device and a method for mounting a photovoltaic device, aiming to solving the problem of low stability and reliability of mounting of the photovoltaic assembly on the color steel tile in the related art.

In a first aspect, some embodiments of the present disclosure provides a photovoltaic device, comprising: a color steel tile comprising at least one angle relaxation portion; a bonding layer arranged on a top wall of the angle relaxation portion; and a photovoltaic assembly arranged on one side of the color steel tile and connected to the color steel tile through the bonding layer. The bonding layer comprises a first bonding portion and a second bonding portion arranged along a first direction; and in the first direction, a ratio of a dimension of the first bonding portion to a dimension of the second bonding portion ranges from 0.1 to 0.5.

In some embodiments, in the first direction, the first bonding portion and the second bonding portion form a continuous structure.

In some embodiments, in the first direction, the first bonding portion and the second bonding portion are arranged at an interval.

In some embodiments, in the first direction, the first bonding portion and the second bonding portion are arranged alternately.

In some embodiments, the first direction is parallel to a width direction of the color steel tile.

In some embodiments, the color steel tile comprises two angle relaxation portions; the two angle relaxation portions are arranged along the width direction of the color steel tile, and each of the two angle relaxation portions is provided with the bonding layer; the first bonding portions of the two angle relaxation portions are arranged at a position where the two angle relaxation portions are close to each other; and the second bonding portions of the two angle relaxation portions are arranged at positions where the two angle relaxation portions are away from each other.

In some embodiments, the first direction is parallel to a length direction of the color steel tile.

In some embodiments, along the length direction of the color steel tile, a dimension of the bonding layer is the same as a dimension of the angle relaxation portion, or the dimension of the bonding layer is smaller than the dimension of the angle relaxation portion.

In some embodiments, the bonding layer comprises a plurality of bonding parts arranged at intervals along a length direction of the color steel tile, and one of the plurality of bonding parts at least comprises one first bonding portion and one second bonding portion.

In some embodiments, along the length direction of the color steel tile, a spacing distance between two adjacent bonding parts satisfies: 0<D≤200 mm.

In some embodiments, along the length direction of the color steel tile, a dimension of one of the plurality of bonding parts ranges from 100 mm to 400 mm.

In some embodiments, along a height direction of the color steel tile, a dimension of the bonding layer ranges from 1 mm to 4 mm.

In some embodiments, each of the first bonding portion and the second bonding portion extends along a second direction that intersects with the first direction; and in the second direction, a dimension of the first bonding portion is different from a dimension of the second bonding portion.

In some embodiments, along a height direction of the color steel tile, a projection area of the top walls of all of the at least one angle relaxation portion on the color steel tile is T, and a projection area of the second bonding portions arranged on the bonding layers of all of the at least one angle relaxation portion is S, where a ratio of S to T ranges from 0.5 to 0.95.

In some embodiments, the color steel tile comprises one angle relaxation portion; the bonding layer comprises a plurality of bonding parts arranged at intervals along a length direction of the color steel tile; one of the plurality of bonding parts at least comprises one first bonding portion and one second bonding portion; and along a height direction of the color steel tile, a ratio of a projection area of the second bonding portion of one of the plurality of bonding parts to a projection area of the top wall of the angle relaxation portion is less than or equal to 0.2.

In some embodiments, the color steel tile comprises two angle relaxation portions; the two angle relaxation portions are arranged along a width direction of the color steel tile, and each of the two angle relaxation portions is provided with the bonding layer; and along a height direction of the color steel tile, a ratio of a total projection area of the second bonding portion on one of the two angle relaxation portions is the same as a total projection area of the second bonding portion on the other one of the two angle relaxation portions.

In some embodiments, along the height direction of the color steel tile, for each of the two angle relaxation portions, a ratio of the total projection area of the second bonding portion to a projection area of the top wall of the angle relaxation portion corresponding thereto is less than or equal to 0.2.

In some embodiments, the photovoltaic device further comprises a clamp, the clamp is connected to the color steel tile, and the photovoltaic assembly is connected to the clamp.

In a second aspect, some embodiments of the present disclosure provides a method for mounting a photovoltaic device. The photovoltaic device comprises at least one color steel tile and a photovoltaic assembly. The method comprises: providing a first bonding portion on an angle relaxation portion of one of the at least one color steel tile; and providing, on the angle relaxation portion, a second bonding portion with a curing speed lower than that of the first bonding portion, the second bonding portion and the first bonding portion being arranged along a first direction. In the first direction, a ratio of a dimension of the first bonding portion to a dimension of the second bonding portion ranges from 0.1 to 0.5.

In some embodiments, the method further comprises: clamping, by using a clamp, a male rib of one of the at least one color steel tile and a female rib of another one of the at least one color steel tile adjacent thereto; and connecting the photovoltaic assembly to the clamp.

It should be understood that the general description above and the detailed description in the following are merely exemplary and illustrative, and cannot limit the present disclosure.

### BRIEF DESCRIPTION OF DRAWINGS

In order to better illustrate the technical solutions of the embodiments of the present disclosure, the accompanying drawings used in the embodiments are briefly introduced below. Obviously, the accompanying drawings in the following description are only some embodiments of the present disclosure. For those of ordinary skill in the art, other accompanying drawings may be obtained based on these accompanying drawings without any creative efforts.

FIG. 1 is a schematic diagram of a photovoltaic device according to some embodiments of the present disclosure;

FIG. 2 is a schematic diagram of a bonding layer according to some embodiments of the present disclosure;

FIG. 3 is a schematic diagram of a bonding layer according to some embodiments of the present disclosure;

FIG. 4 is a schematic diagram of a bonding layer according to some embodiments of the present disclosure;

FIG. 5 is a schematic diagram of a bonding layer according to some embodiments of the present disclosure;

FIG. 6 is a schematic diagram of a bonding layer according to some embodiments of the present disclosure;

FIG. 7 is a schematic diagram of a bonding layer according to some embodiments of the present disclosure;

FIG. 8 is a schematic diagram of a bonding layer according to some embodiments of the present disclosure;

FIG. 9 is a schematic diagram of a bonding layer according to some embodiments of the present disclosure;

FIG. 10 is a schematic diagram of a bonding layer according to some embodiments of the present disclosure;

FIG. 11 is a schematic diagram of a photovoltaic device according to some embodiments of the present disclosure;

FIG. 12 is a schematic diagram of a second bonding portion according to some embodiments of the present disclosure;

FIG. 13 is a schematic diagram of a second bonding portion according to some embodiments of the present disclosure;

FIG. 14 is a schematic diagram of a second bonding portion according to some embodiments of the present disclosure;

FIG. 15 is a schematic diagram of a second bonding portion according to some embodiments of the present disclosure;

FIG. 16 is a schematic diagram of a second bonding portion according to some embodiments of the present disclosure;

FIG. 17 is a schematic diagram of a second bonding portion according to some embodiments of the present disclosure; and

FIG. 18 is a schematic diagram of an overlock structure of a color steel tile provided with a bonding platform according to some embodiments of the present disclosure.

### DESCRIPTION OF EMBODIMENTS

In order to better illustrate the technical solution of the present disclosure, embodiments of the present disclosure are described in detail below with reference to the accompanying drawings.

It should be understood that the embodiments described are only some rather than all of the embodiments of the present disclosure. All other embodiments acquired by those of ordinary skill in the art without creative efforts based on the embodiments of the present disclosure fall within the protection scope of the present disclosure.

The terms used in the embodiments of the present disclosure are intended solely to describe particular embodiments and are not intended to limit the present disclosure. As used in the specification of the present disclosure and the appended claims, the singular forms of “a/an”, “said”, and “the” are intended to include plural forms, unless otherwise clearly specified in the context.

It should be understood that the term “and/or” used herein only describes an association relationship between associated objects and represents that three relationships may exist. For example, A and/or B may represent the following three cases: only A exists, both A and B exist, and only B exists. In addition, the character “/” herein generally means that associated objects before and after it are in an “or” relationship.

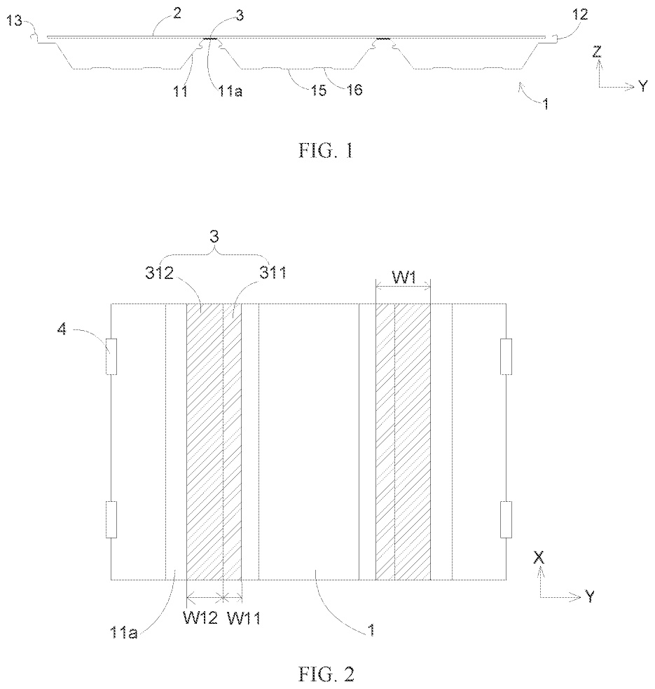

As shown in FIG. 1 and FIG. 2, in a first aspect of some embodiments of the present disclosure, a photovoltaic device is provided. The photovoltaic device includes a color steel tile 1, a bonding layer 3, and a photovoltaic assembly 2. The color steel tile 1 includes at least one angle relaxation portion 11. The bonding layer 3 is arranged at a top wall 11a of the angle relaxation portion 11. The photovoltaic assembly 2 is located at a side of the color steel tile 1 and connected to the color steel tile through the bonding layer 3. The bonding layer 3 includes a first bonding portion 311 and a second bonding portion 312 arranged along a first direction. In the first direction, a ratio of a dimension W11 of the first bonding portion 311 to a dimension W12 of the second bonding portion 312 satisfies: 0.1 to 0.5.

The color steel tile 1 may be mounted on a roof, a wall, or the ground of a building, and the building may be a factory, a warehouse, or the like of a production-oriented enterprise. The color steel tile 1 includes an angle relaxation portion 11, a male rib 12, a female rib 13, a bottom plate 15, and a reinforcing rib 16. The bottom plate 15 serves as a main body of the color steel tile 1 and can be in contact with a structure of a building to play a supporting role. Along a width direction Y of the color steel tile 1, two ends of the bottom plate 15 are provided with the male rib 12 and the female rib 13, respectively. The angle relaxation portion 11 is located between the male rib 12 and the female rib 13, and the angle relaxation portion 11 is connected to the bottom plate 15 and protrudes from the bottom plate 15, to form a cavity. The angle relaxation portion 11 includes a top wall 11a, and both the first bonding portion 311 and the second bonding portion 312 are arranged at the top wall 11a. That is, the top wall 11a of the angle relaxation portion 11 is a bonding surface of the first bonding portion 311 and the second bonding portion 312. When the photovoltaic assembly 2 is connected to the color steel tile 1, along a height direction Z of the color steel tile 1, each of the first bonding portion 311 and the second bonding portion 312 includes an end connected to the top wall 11a of the angle relaxation portion 11, and another end connected to the photovoltaic assembly 2. For example, the top wall 11a of the angle relaxation portion 11 has a smooth surface to improve a bonding effect of the first bonding portion 311 and the second bonding portion 312. One, two, or more angle relaxation portions 11 can be provided. When the color steel tile 1 includes two or more angle relaxation portions 11, the top wall 11a of each angle relaxation portion 11 may be provided with the bonding layer 3.

The first bonding portion 311 may be a solid adhesive. For example, the first bonding portion 311 may be a double-sided adhesive tape. A base material of the adhesive tape may be sponge, foam, tissue paper, a polypropylene film, a polyvinyl chloride film, fiber cloth, fiber plastic, or other material. The first bonding portion 311 may be arranged on the angle relaxation portion 11 by means of a taping machine.

The second bonding portion 312 may be a structural adhesive. The structural adhesive may be an adhesive such as a polycarbonate adhesive, an epoxy resin adhesive, a silicone adhesive, an acrylic adhesive, or a polyurethane adhesive. For example, the second bonding portion 312 may be one of the above-mentioned adhesives, or the second bonding portion 312 may be a combination of the above-mentioned adhesives. The second bonding portion 312 may be arranged on the angle relaxation portion 11 by means of a gluing apparatus.

As can be seen from the above description, the first bonding portion 311 and the second bonding portion 312 are two different adhesives, and their curing speeds are different. The curing speed of the first bonding portion 311 may be greater than that of the second bonding portion 312. Due to the difference in the curing speeds, the first bonding portion 311 and the second bonding portion 312 can exhibit different fluidities during usage. For example, the first bonding portion 311 may be an adhesive that has a relatively high degree of curing or has been cured, which has low fluidity or no fluidity when arranged on the angle relaxation portion 11. Since the curing speed of the second bonding portion 312 is relatively low, the second bonding portion 312 still has strong fluidity for a certain period of time after being arranged on the angle relaxation portion 11. Since the first bonding portion 311 is featured with a high degree of curing and a low flowing property, during the mounting of the photovoltaic assembly 2, the first bonding portion 311 can immediately bond the photovoltaic assembly 2. That is, the first bonding portion 311 can temporarily fix and position the photovoltaic assembly 2, thereby reducing a possibility of sliding and deviation of the photovoltaic assembly 2 on the color steel tile 1. In this way, the photovoltaic assembly 2 can be stably placed at a preset mounting position, to improve accuracy of mounting of the photovoltaic assembly 2. Further, since the first bonding portion 311 can also provide certain bonding strength for the photovoltaic assembly 2, the arrangement of the first bonding portion 311 also helps improve stability of bonding of the photovoltaic assembly 2. The second bonding portion 312 plays a major role in bonding and fixing the photovoltaic assembly 2. Since the second bonding portion 312 is featured with a low curing speed, the second bonding portion 312 can flow on the angle relaxation portion 11 after gluing. Therefore, the second bonding portion 312 can fully flow and fill a gap between the angle relaxation portion 11 and the photovoltaic assembly 2, thereby reducing a possibility of an unbonded portion between the photovoltaic assembly 2 and the angle relaxation portion 11 and also helping increase an overall bonding area of the photovoltaic assembly 2. Therefore, the arrangement of the second bonding portion 312 helps improve uniformity, stability, and reliability of bonding of the photovoltaic assembly 2.

If the bonding layer 3 only includes the first bonding portion 311, the bonding layer 3 has weak overall bonding performance and a poor bonding effect, which cannot meet a bonding requirement of the photovoltaic assembly 10, causing easy fall-off of the photovoltaic assembly 10 from the color steel tile 20 under an external force. As a result, the photovoltaic device as a whole cannot operate normally. If the bonding layer 3 only includes the second bonding portion 312, an overall curing speed of the bonding layer 3 is relatively low, and the bonding layer 3 has weak bonding performance during the curing and cannot stably bond the photovoltaic assembly 10. As a result, during a wait for the second bonding portion 312 to complete curing, the photovoltaic assembly 10 is prone to position deviation on the color steel tile 20, resulting in an inaccurate mounting position, which may easily cause failure of mounting of the photovoltaic assembly 10. Moreover, the photovoltaic assembly 10 is also easy to move relative to the color steel tile 20 or be directly separated from the color steel tile 20 under an external force. Therefore, in some embodiments of the present disclosure, the arrangement of both the first bonding portion 311 and the second bonding portion 312 is conducive to stable, reliable, and accurate mounting of the photovoltaic assembly 2, thereby helping achieve normal operation of the photovoltaic assembly 2.

In the related art, stability of mounting of the photovoltaic assembly on the color steel tile is poor, and under an external force, the photovoltaic assembly is easily deformed or easily detached from the color steel tile. As a result, the photovoltaic device cannot be used normally. Compared with the related art, the photovoltaic assembly 2 is connected to the color steel tile 1 through the first bonding portion 311 and the second bonding portion 312 in some embodiments of the present disclosure, thereby helping improve stability and reliability of mounting of the photovoltaic assembly 2, and at the same time, also helping improve the load resistance capability of the photovoltaic assembly 2, so that the photovoltaic assembly 2 has relatively excellent wind resistance. In this way, it reduces a possibility of deformation of the photovoltaic assembly 2, or shaking of the photovoltaic assembly 2 on the color steel tile 1, or detachment of the photovoltaic assembly 2 from the color steel tile 1 under an external force. The first bonding portion 311 can play a temporary fixing role, which helps improve accuracy of mounting of the photovoltaic assembly 2, and enables the photovoltaic assembly 2 to be accurately mounted to a preset mounting position, thereby helping increase a success rate of mounting of the photovoltaic assembly 2. The second bonding portion 312 plays a main fixing role to improve stability of mounting of the photovoltaic assembly 2. Therefore, under a joint action of the first bonding portion 311 and the second bonding portion 312, it is conducive to stable, reliable, and accurate mounting of the photovoltaic assembly 2, thereby helping achieve normal operation of the photovoltaic assembly 2.

The first bonding portion 311 and the second bonding portion 312 are arranged along a first direction. In the first direction, a ratio of a dimension W11 of the first bonding portion 311 to a dimension W12 of the second bonding portion 312 satisfies: 0.1 to 0.5. For example, the ratio of the dimension of the first bonding portion 311 to the dimension of the second bonding portion 312 may be 0.1, 0.15, 0.2, 0.25, 0.3, 0.35, 0.4, 0.45, or 0.5, and may certainly be other values in the above-mentioned range. If the ratio of the dimension of the first bonding portion 311 to the dimension of the second bonding portion 312 is excessively small, that is, the dimension of the first bonding portion 311 is smaller or the dimension of the second bonding portion 312 is larger, it is easy to reduce reliability of the first bonding portion 311 and affect a bonding effect of the first bonding portion 311. As a result, the photovoltaic assembly 2 is prone to sliding and deviation on the color steel tile 1, thereby affecting accuracy of mounting of the photovoltaic assembly 2. If the ratio of the dimension of the first bonding portion 311 to the dimension of the second bonding portion 312 is excessively large, that is, the dimension of the first bonding portion 311 is larger or the dimension of the second bonding portion 312 is smaller, it is easy to reduce reliability of the second bonding portion 312 and affect a bonding effect of the second bonding portion 312. As a result, it is difficult for the photovoltaic assembly 2 to be stably connected to the color steel tile 1, and the photovoltaic assembly 2 is easy to fall off from the color steel tile 1 under an external force, thereby affecting stability and reliability of mounting of the photovoltaic assembly 2. Therefore, in some embodiments of the present disclosure, the ratio of the dimension of the first bonding portion 311 to the dimension of the second bonding portion 312 is limited within a reasonable range, thereby helping improve respective bonding performances of the first bonding portion 311 and the second bonding portion 312. Therefore, it can improve stability and accuracy of mounting of the photovoltaic assembly 2, and help improve the load resistance capability of the photovoltaic assembly 2, to improve wind resistance of the photovoltaic assembly 2.

Along the height direction Z of the color steel tile 1, a dimension of the bonding layer 3 satisfies: 1 mm to 4 mm. An overall thickness dimension of the bonding layer 3 may be 1 mm, 1.5 mm, 2 mm, 2.5 mm, 3 mm, 3.5 mm, or 4 mm, and may certainly be other values in the above-mentioned range. Thickness dimensions of the first bonding portion 311 and the second bonding portion 312 may be the same. The limitation on the thickness dimension of the bonding layer 3 helps improve stability of bonding of the photovoltaic assembly 2, reduces a possibility of poor stability of the connection between the photovoltaic assembly 2 and the color steel tile 1 caused by an excessively large or excessively small height dimension of the bonding layer 3, and also helps save a usage amount of the bonding layer 3, thereby helping reduce mounting costs of the photovoltaic assembly 2 and helping keep a self-weight of the photovoltaic device within a reasonable range, so as to facilitate mounting and use of the photovoltaic device.

As shown in FIG. 2, the first bonding portion 311 and the second bonding portion 312 may be arranged along the width direction Y of the color steel tile 1. That is, the first direction may be parallel to the width direction Y of the color steel tile 1. In the width direction Y of the color steel tile 1, the ratio of the dimension W11 of the first bonding portion 311 to the dimension W12 of the second bonding portion 312 satisfies: 0.1 to 0.5.

In some embodiments, the bonding layer 3 includes only one first bonding portion 311 and only one second bonding portion 312, and the one first bonding portion 311 and the one second bonding portion 312 are arranged along the width direction Y of the color steel tile 1. In some other embodiments, the bonding layer 3 includes more than one first bonding portion 311 or more than one second bonding portion 312. For example, the bonding layer 3 includes two first bonding portions 311 and one second bonding portion 312, and along the width direction Y of the color steel tile 1, the second bonding portion 312 is located between the two first bonding portions 311.

As shown in FIG. 2, in a possible embodiment, in the width direction Y of the color steel tile 1, the first bonding portion 311 and the second bonding portion 312 are arranged in a continuous manner. Such an arrangement can help improve stability of the arrangement of the first bonding portion 311 and the second bonding portion 312 on the angle relaxation portion 11 and help improve a bonding effect of the bonding layer 3 on the photovoltaic assembly 2, thereby helping improve accuracy and stability of the mounting between the photovoltaic assembly 2 and the color steel tile 1.

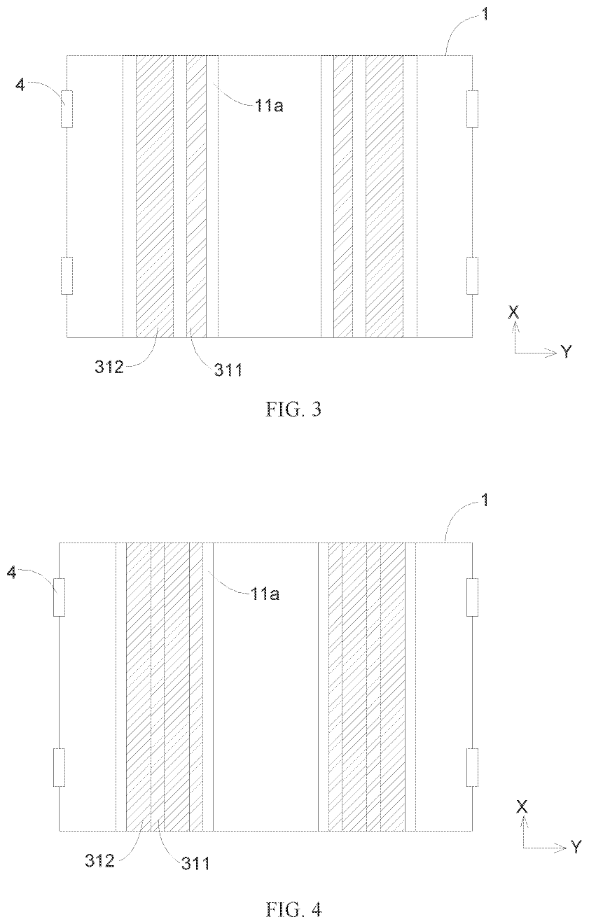

As shown in FIG. 3, in a possible embodiment, in the width direction Y of the color steel tile 1, the first bonding portion 311 and the second bonding portion 312 are arranged spaced from each other. A spacing distance between the first bonding portion 311 and the second bonding portion 312 can be designed according to a mounting requirement of the photovoltaic assembly 2. Such an arrangement can help improve flexibility of the arrangement of the first bonding portion 311 and the second bonding portion 312 on the angle relaxation portion 11, to realize an accurate and stable connection between the photovoltaic assembly 2 and the color steel tile 1. Further, such an arrangement can help save usage amounts of the first bonding portion 311 and the second bonding portion 312 to reduce mounting costs of the photovoltaic assembly 2.

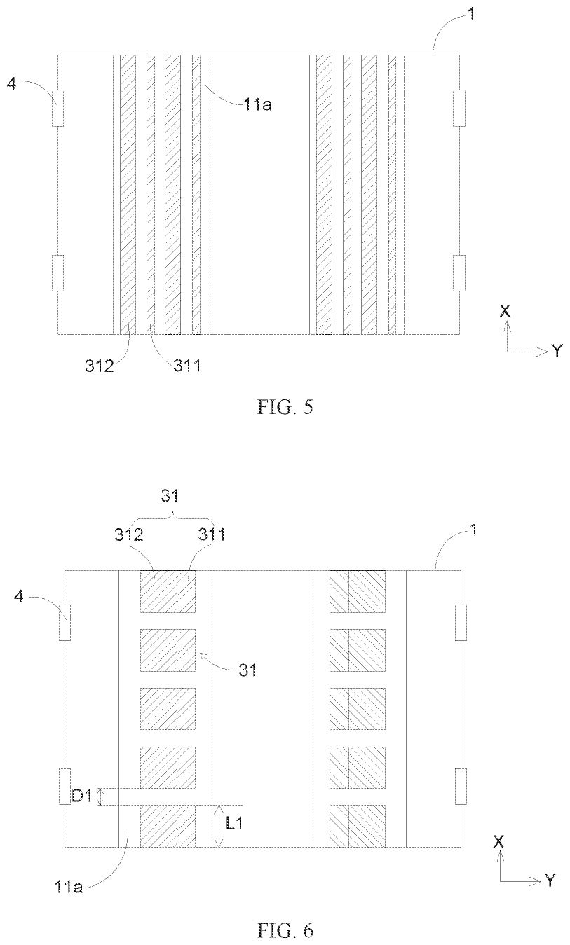

As shown in FIG. 4 and FIG. 5, in a possible embodiment, in the width direction Y of the color steel tile 1, the first bonding portion 311 and the second bonding portion 312 are arranged alternately. The bonding layer 3 includes a plurality of first bonding portions 311 and a plurality of second bonding portions 312. As shown in FIG. 4, in some embodiments, the plurality of first bonding portions 311 and the plurality of second bonding portions 312 are alternately arranged in a continuous manner along the width direction Y of the color steel tile 1. As shown in FIG. 5, in some other embodiments, the plurality of first bonding portions 311 and the plurality of second bonding portions 312 are alternately arranged at intervals along the width direction Y of the color steel tile 1. This design helps realize uniform arrangement of the first bonding portions 311 and the second bonding portions 312 on the angle relaxation portion 11, thereby helping improve an overall bonding effect of the bonding layer 3 and helping improve stability and accuracy of the connection between the photovoltaic assembly 2 and the color steel tile 1.

As shown in FIG. 2, in a possible embodiment, the color steel tile 1 includes two angle relaxation portions 11. The two angle relaxation portions 11 are arranged along the width direction Y of the color steel tile 1. Each of the two angle relaxation portions 11 is provided with the bonding layer 3, the first bonding portions 311 are located on a side where the two angle relaxation portions 11 are close to each other, and the second bonding portions 312 are located on a side where the two angle relaxation portions 11 are away from each other.

The bonding layers 3 on the two angle relaxation portions 11 may be arranged symmetrically. That is, on each angle relaxation portion 11, the first bonding portion 311 is located at an inner side of the angle relaxation portion 11, and the second bonding portion 312 is located at an outer side of the angle relaxation portion 11. Such an arrangement facilitates gluing to the color steel tile 1, thereby helping improve convenience of the arrangement of the first bonding portion 311 and the second bonding portion 312. At the same time, the arrangement of the bonding layer 3 on each of the two angle relaxation portions 11 helps further improve the stability of bonding of the photovoltaic assembly 2, thereby helping improve stability of the connection between the photovoltaic assembly 2 and the color steel tile 1, and also helping further improve the wind resistance of the photovoltaic assembly 2.

As shown in FIG. 2, in a possible embodiment, along the width direction Y of the color steel tile 1, a dimension W1 of the bonding layer 3 satisfies: 20 mm to 40 mm.

Along the width direction Y of the color steel tile 1, an overall dimension of the bonding layer 3 may be the same as the dimension of the angle relaxation portion 11 or may be smaller than the dimension of the angle relaxation portion 11. For example, the dimension of the bonding layer 3 may be 20 mm, 22 mm, 24 mm, 26 mm, 28 mm, 30 mm, 32 mm, 34 mm, 36 mm, 38 mm, or 40 mm, and may certainly be other values in the above-mentioned range.

The limitation on the dimension of the bonding layer 3 reduces a possibility of overflow of the bonding layer 3 from the angle relaxation portion 11, that is, reduces a possibility of glue overflow of the photovoltaic device, thereby improving stability of the arrangement of the bonding layer 3. At the same time, this design also helps improve the bonding effect of the bonding layer 3, thereby helping improve stability of bonding of the photovoltaic assembly 2, reducing a possibility of separation of the photovoltaic assembly 2 from the color steel tile 1, and helping improve wind resistance of the photovoltaic assembly 2.

As shown in FIG. 2, in a possible embodiment, the first bonding portion 311 and the second bonding portion 312 are arranged along the width direction Y of the color steel tile 1. Along a length direction X of the color steel tile 1, the dimension of the bonding layer 3 is the same as that of the angle relaxation portion 11. That is, the bonding layer 3 may have a same length as the angle relaxation portion 11. This helps increase a bonding area of the bonding layer 3, thereby helping improve the bonding effect of the bonding layer 3.

In another possible embodiment, along the length direction X of the color steel tile 1, the dimension of the bonding layer 3 is smaller than that of the angle relaxation portion 11, to help save a usage amount of the bonding layer 3 and reduce mounting costs of the photovoltaic assembly 2.

The first bonding portion 311 and the second bonding portion 312 are arranged along the width direction Y of the color steel tile 1, and the first bonding portion 311 and the second bonding portion 312 extend along the length direction of the color steel tile 1. As shown in FIG. 2, in a possible embodiment, along the length direction X of the color steel tile 1, a length of the first bonding portion 311 may be the same as that of the second bonding portion 312. Further, each of the two lengths may be the same as the length of the angle relaxation portion 11. This design helps increase bonding areas of the first bonding portion 311 and the second bonding portion 312, thereby helping improve the overall bonding effect of the bonding layer 3, and thus helping improve stability and reliability of the connection between the photovoltaic assembly 2 and the color steel tile 1, and also helping improve the load resistance capability of the photovoltaic assembly 2. Further, this design also helps improve accuracy of mounting of the photovoltaic assembly 2, so that the photovoltaic assembly 2 can be stably placed at the corresponding mounting position to increase the success rate of mounting of the photovoltaic assembly 2.

In another possible embodiment, along the length direction X of the color steel tile 1, the length of the first bonding portion 311 may be different from that of the second bonding portion 312, and the length of the first bonding portion 311 may be greater than that of the second bonding portion 312 or less than that of the second bonding portion 312. A specific design may be determined according to a bonding requirement of the photovoltaic assembly 2, to improve flexibility of the arrangement of the bonding layer 3.

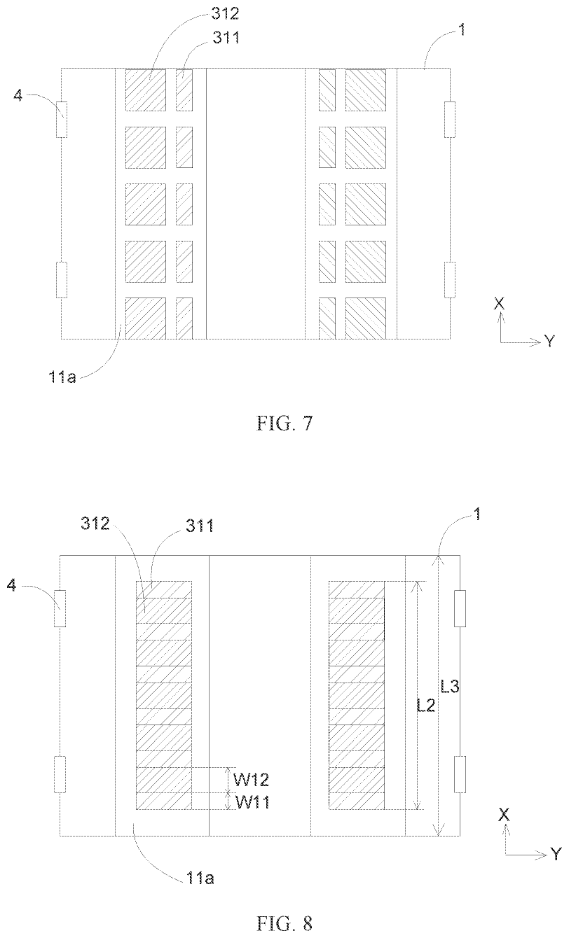

As shown in FIG. 6, in a possible embodiment, the bonding layer 3 includes a plurality of bonding parts 31, and one of the plurality of bonding parts 31 at least includes one first bonding portion 311 and one second bonding portion 312. The plurality of bonding parts 31 are arranged at intervals along the length direction X of the color steel tile 1. The first bonding portion 311 and the second bonding portion 312 of the bonding part 31 are arranged along the width direction Y of the color steel tile 1. As shown in FIG. 6, of the bonding portion 31, the first bonding portion 311 and the second bonding portion 312 may be arranged in a continuous manner. Or, as shown in FIG. 7, of the bonding portion 31, the first bonding portion 311 and the second bonding portion 312 may be arranged at an interval. The arrangement of the plurality of bonding parts 31 at intervals on the angle relaxation portion 11 helps improve stability of bonding of the photovoltaic assembly 2 and accuracy of mounting of the photovoltaic assembly 2, and at the same time, further helps save a usage amount of the adhesive, thereby helping reduce mounting costs of the photovoltaic device. Further, it helps reduce a weight of the photovoltaic device, thereby facilitating the mounting and use of the photovoltaic device.

As shown in FIG. 6, in a possible embodiment, along the length direction X of the color steel tile 1, a spacing distance D1 between two adjacent bonding parts 31 satisfies: 0<D≤200 mm. For example, the spacing distance D may be 0.05 mm, 0.2 mm, 0.8 mm, 1.2 mm, 5 mm, 8 mm, 15 mm, 25 mm, 45 mm, 65 mm, 75 mm, 85 mm, 100 mm, 125 mm, 150 mm, 175 mm, 190 mm, or 200 mm, and may certainly be other values in the above-mentioned range.

In some embodiments, spacing distances between two adjacent bonding parts 31 may be the same. That is, the plurality of bonding parts 31 may be evenly arranged on the angle relaxation portion 11. This design helps improve evenness of the arrangement of the bonding layer 3, thereby helping improve the bonding effect of the bonding layer 3 and helping improve stability of the connection between the photovoltaic assembly 2 and the color steel tile 1, and at the same time, further helps improve the load resistance capability of the photovoltaic assembly 2 and reduce a possibility of deformation of the photovoltaic assembly 2 or fall-off from the color steel tile 1 under an external force. In some other embodiments, the plurality of bonding parts 31 may be unevenly arranged on the angle relaxation portion 11, to improve flexibility of the arrangement of the bonding layer 3.

As shown in FIG. 6, in a possible embodiment, along the length direction X of the color steel tile 1, a dimension L1 of each of the plurality of bonding parts 31 satisfies: 100 mm to 400 mm.

The dimension of one bonding part 31 may be 100 mm, 140 mm, 180 mm, 220 mm, 260 mm, 300 mm, 340 mm, 380 mm, or 400 mm, and may certainly be other values in the above-mentioned range. The dimension of the first bonding portion 311 may be the same as that of the second bonding portion 312. The limitation on the dimension of the bonding layer 3 enables the dimension of the first bonding portion 311 and the dimension of the second bonding portion 312 to fall within a reasonable range, which helps improve stability of bonding of the photovoltaic assembly 2 and save a usage amount of the adhesive, thereby helping reduce use costs of the photovoltaic device.

As shown in FIG. 8, the first bonding portion 311 and the second bonding portion 312 may be arranged along the length direction X of the color steel tile 1. That is, the first direction may be parallel to the length direction X of the color steel tile 1. In the length direction X of the color steel tile 1, the ratio of the dimension W11 of the first bonding portion 311 to the dimension W12 of the second bonding portion 312 satisfies: 0.1 to 0.5.

As shown in FIG. 8, in a possible embodiment, in the length direction X of the color steel tile 1, the first bonding portion 311 and the second bonding portion 312 are arranged in a continuous manner. This design helps improve stability of the arrangement of the first bonding portion 311 and the second bonding portion 312 on the angle relaxation portion 11 and helps improve the bonding effect of the bonding layer 3 on the photovoltaic assembly 2, thereby helping improve accuracy and stability of the mounting between the photovoltaic assembly 2 and the color steel tile 1.

For example, the bonding layer 3 may include a plurality of first bonding portions 311 and a plurality of second bonding portions 312, and the first bonding portions 311 and the second bonding portions 312 are alternately arranged in a continuous manner along the length direction X of the color steel tile 1.

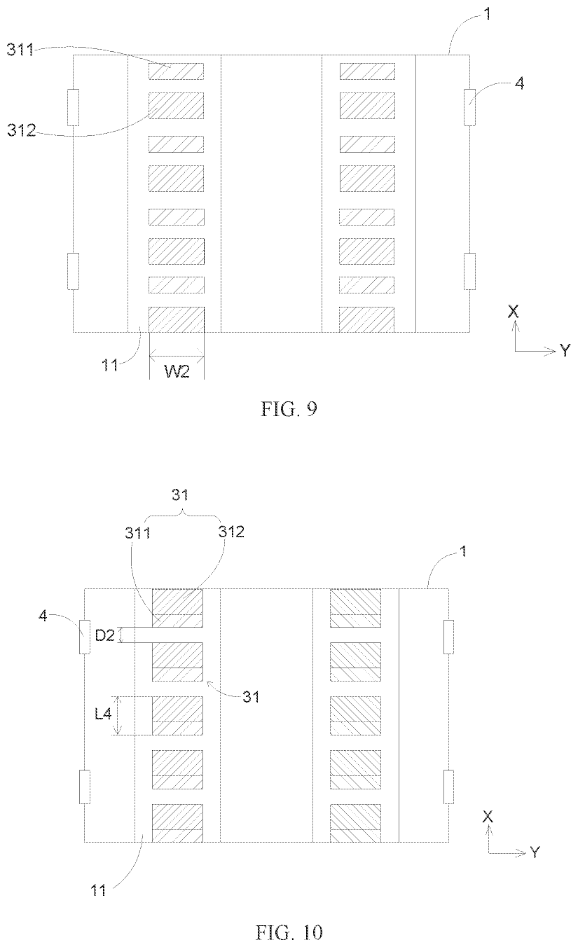

As shown in FIG. 9, in a possible embodiment, in the length direction X of the color steel tile 1, the first bonding portion 311 and the second bonding portion 312 are arranged at an interval. This design helps improve flexibility of the arrangement of the first bonding portion 311 and the second bonding portion 312 on the angle relaxation portion 11, to realize an accurate and stable connection between the photovoltaic assembly 2 and the color steel tile 1. Further, this design further helps save usage amounts of the first bonding portion 311 and the second bonding portion 312, to reduce mounting costs of the photovoltaic assembly 2.

For example, the bonding layer 3 may include a plurality of first bonding portions 311 and a plurality of second bonding portions 312, and the first bonding portions 311 and the second bonding portions 312 are alternately arranged at intervals along the length direction X of the color steel tile 1. According to a bonding requirement of the photovoltaic assembly 2 in actual mounting, the first bonding portions 311 and the second bonding portions 312 may be evenly arranged on the angle relaxation portion 11. That is, spacing distances between any two adjacent first bonding portions 311 and any second bonding portions 312 are the same. Or, the first bonding portions 311 and the second bonding portions 312 may be unevenly arranged on the angle relaxation portion 11. That is, the spacing distances between the first bonding portions 311 and the second bonding portions 312 may gradually increase or gradually decrease towards an edge of the angle relaxation portion 11.

As shown in FIG. 9, in a possible embodiment, along the width direction Y of the color steel tile 1, a dimension W2 of the bonding layer 3 satisfies: 10 mm to 30 mm.

Along the width direction Y of the color steel tile 1, the dimension of the bonding layer 3 may be the same as that of the angle relaxation portion 11 or may be smaller than that of the angle relaxation portion 11. For example, an overall dimension of the bonding layer 3 may be 10 mm, 15 mm, 20 mm, 25 mm, 30 mm, 35 mm, 40 mm, 45 mm, or 50 mm, and may certainly be other values in the above-mentioned range. Along the width direction Y of the color steel tile 1, the dimensions of the first bonding portion 311 and the second bonding portion 312 may be the same. The limitation on the dimension of the bonding layer 3 helps improve stability of the arrangement of the bonding layer 3 on the angle relaxation portion 11 and reduces a possibility of overflow of the bonding layer 3 from the angle relaxation portion 11. At the same time, this design also helps keep the bonding area of the bonding layer 3 within a reasonable range, thereby helping improve the bonding effect of the bonding layer 3, helping improve stability of bonding of the photovoltaic assembly 2, and improving accuracy of mounting of the photovoltaic assembly 2.

In a possible embodiment, along the length direction X of the color steel tile 1, the dimension of the bonding layer 3 is the same as that of the angle relaxation portion 11.

Along the length direction X of the color steel tile 1, the first bonding portion 311 and the second bonding portion 312 may be alternately arranged in a continuous manner, and the dimension of the entire bonding layer 3 is the same as that of the angle relaxation portion 11. That is, the bonding layer 3 may have a same length as the angle relaxation portion 11. This design helps increase the bonding area of the bonding layer 3, thereby helping improve the bonding effect of the bonding layer 3, to improve stability of bonding of the photovoltaic assembly 2 and further reduce the possibility of fall-off of the photovoltaic assembly 2 from the angle relaxation portion 11.

As shown in FIG. 8, in another possible embodiment, along the length direction X of the color steel tile 1, the dimension of the bonding layer 3 is smaller than that of the angle relaxation portion 11.

For example, along the length direction X of the color steel tile 1, a ratio of a dimension L2 of the bonding layer 3 to a dimension L3 of the angle relaxation portion 11 satisfies: 0.05 to 0.2. The first bonding portion 311 and the second bonding portion 312 may be alternately arranged in a continuous manner. The ratio of the dimension of the bonding layer 3 to the dimension of the angle relaxation portion 11 may be 0.05, 0.07, 0.09, 0.1, 0.12, 0.14, 0.16, 0.18, or 0.2, and may certainly be other values in the above-mentioned range. The limitation on the dimension of the bonding layer 3 enables the dimension to be kept within a reasonable range. This design helps improve stability and reliability of the connection between the photovoltaic assembly 2 and the color steel tile 1, and at the same time, further helps improve load resistance performance of the photovoltaic assembly 2. Further, the limitation of the overall dimension of the bonding layer 3 within a reasonable range helps save usage amounts of the first bonding portion 311 and the second bonding portion 312, reduces a possibility of a waste due to excessive usage amounts, and helps reduce mounting costs of the photovoltaic device.

In a possible embodiment, the first bonding portion 311 and the second bonding portion 312 may be arranged along the length direction X of the color steel tile 1, and the first bonding portion 311 and the second bonding portion 312 extend along the width direction Y of the color steel tile 1. In the width direction Y of the color steel tile 1, the dimension of the first bonding portion 311 is different from that of the second bonding portion 312. The dimension of the first bonding portion 311 may be larger than that of the second bonding portion 312 or may be smaller than that of the second bonding portion 312.

As shown in FIG. 8, in another possible embodiment, in the width direction Y of the color steel tile 1, the dimension of the first bonding portion 311 may be the same as that of the second bonding portion 312.

As shown in FIG. 8, the color steel tile 1 may include two angle relaxation portions 11, the two angle relaxation portions 11 are arranged at an interval along the width direction Y of the color steel tile 1. Each of the two angle relaxation portions 11 is provided with the bonding layer 3. The first bonding portions 311 and the second bonding portions 312 may be arranged on the two angle relaxation portions 11 in a same manner or in different manners. The arrangement of the bonding layers 3 on the two angle relaxation portions 11 helps further improve the stability, reliability, and accuracy of mounting of the photovoltaic assembly 2, and at the same time, helps further improve the load resistance capability of the photovoltaic assembly 2, to ensure normal and stable operation of the photovoltaic assembly 2.

As shown in FIG. 10, in a possible embodiment, the bonding layer 3 includes a plurality of bonding parts 31. The bonding part 31 at least includes one first bonding portion 311 and one second bonding portion 312. The plurality of bonding parts 31 are arranged at intervals along the length direction X of the color steel tile 1. The first bonding portion 311 and the second bonding portion 312 of the bonding part 31 may be arranged in a continuous manner along the length direction X of the color steel tile 1. This design helps improve accuracy, stability, and reliability of mounting of the photovoltaic assembly 2, and reduce a possibility of separation of the photovoltaic assembly 2 from the color steel tile 1. Therefore, it improves security of operation of the entire photovoltaic device and also improves the load resistance capability of the photovoltaic assembly 2, so that the photovoltaic assembly 2 may have relatively excellent wind resistance, thereby helping realize normal and stable operation of the photovoltaic assembly 2.

As shown in FIG. 10, in a possible embodiment, along the length direction X of the color steel tile 1, a spacing distance D2 between two adjacent bonding parts 31 satisfies: 0<D≤200 mm.

The plurality of bonding parts 31 are arranged at intervals on the angle relaxation portion 11. For example, the spacing distance between two adjacent bonding parts 31 may be 0.1 mm, 0.5 mm, 1 mm, 10 mm, 20 mm, 40 mm, 60 mm, 80 mm, 100 mm, 120 mm, 140 mm, 160 mm, 180 mm, or 200 mm, and may certainly be other values in the above-mentioned range. For example, the spacing distances between adjacent bonding parts 31 may be different from each other, and the spacing distances between the adjacent bonding parts 31 may gradually increase or gradually decrease along a direction towards an edge of the angle relaxation portion 11.

In a possible embodiment, the spacing distances between adjacent bonding parts 31 are the same.

The plurality of bonding parts 31 are evenly arranged on the angle relaxation portion 11. Such an arrangement helps improve evenness of the arrangement of the bonding parts 31 on the angle relaxation portion 11, thereby helping improve the overall bonding effect of the bonding layer 3 and helping improve stability of bonding of the photovoltaic assembly 2, and at the same time, also helps improve accuracy of mounting of the photovoltaic assembly 2, and reduces a possibility of sliding and deviation of the photovoltaic assembly 2 from the color steel tile 1 during the mounting.

As shown in FIG. 10, in a possible embodiment, along the length direction X of the color steel tile 1, a dimension L4 of one bonding part 31 satisfies: 100 mm to 400 mm.

The dimension of the bonding part 31 may be 100 mm, 150 mm, 200 mm, 250 mm, 300 mm, 350 mm, or 400 mm, and may certainly be other values in the above-mentioned range. The limitation on the dimension of the bonding part 31 enables the dimension to fall within a reasonable range, which helps improve the overall bonding effect of the bonding layer 3, reduces a possibility of unstable bonding of the photovoltaic assembly 2 due to an excessively small dimension of the bonding layer 3, and also reduces a possibility of a waste of materials due to an excessively large dimension of the bonding layer 3.

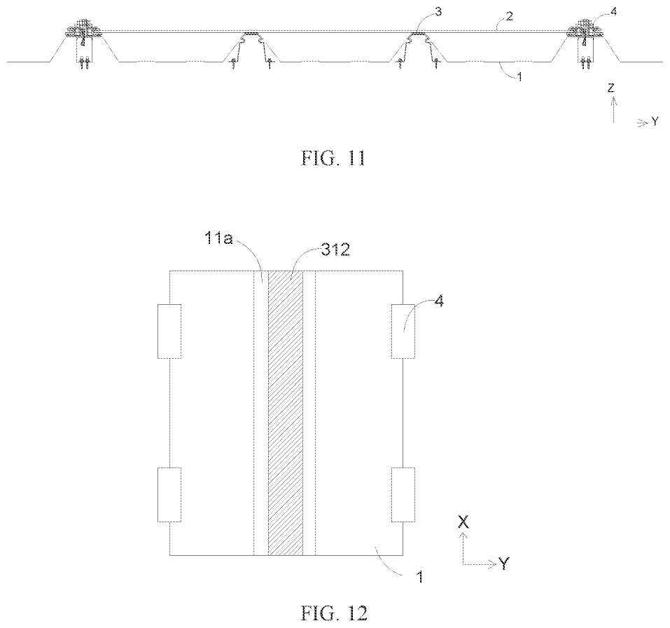

As shown in FIG. 11, in the above embodiments, the photovoltaic device further includes a clamp 4, the clamp 4 is connected to the color steel tile 1, and the photovoltaic assembly 2 is connected to the clamp 4. Two sides of the color steel tile 1 may be clamped by the clamp 4. For example, one color steel tile 1 may be connected to a plurality of clamps 4 at the same time. For example, referring to FIG. 1 together, the color steel tile 1 is provided with a male rib 12 and a female rib 13 at two sides, and the male rib 12 and the female rib 13 may be clamped by the clamp 4, respectively. In this embodiment, while being connected to the color steel tile 1 through the bonding layer 3, the photovoltaic assembly 2 may also be connected to the color steel tile 1 through the clamp 4. This design helps further improve the stability of the connection between the photovoltaic assembly 2 and the color steel tile 1, thereby helping improve wind resistance of the photovoltaic assembly 2, reducing a possibility of deformation of the photovoltaic assembly 2 or detachment from the color steel tile 1 under an external force, and helping realize normal and stable operation of the photovoltaic assembly 2.

The second bonding portion 312 plays a main role in fixing the photovoltaic assembly 2. In some embodiments of the present disclosure, a proportional relationship between an area of the second bonding portion 312 and an area of the angle relaxation portion 11 is designed to improve stability of bonding of the photovoltaic assembly 2, save a usage amount of the second bonding portion 312, and reduce mounting costs of the photovoltaic assembly 2. It is to be noted that the design of the above-mentioned proportional relationship is based on the fact that the bonding layer 3 includes both the first bonding portion 311 and the second bonding portion 312. In order to clearly show a relationship between the second bonding portion 312 and the angle relaxation portion 11, FIG. 12 to FIG. 17 only show the second bonding portion 312 and the angle relaxation portion 11, and do not show the first bonding portion 311.

In a possible embodiment, along the height direction Z of the color steel tile 1, a projection area of the top walls 11a of all the angle relaxation portions 11 on the color steel tile 1 is T, a projection area of the second bonding portions 312 of all the bonding layers 3 is S, and a ratio of S to T is 0.5 to 0.95. For example, the ratio of the projection area S of all the second bonding portions 312 to the projection area T of the top walls 11a of all the angle relaxation portions 11 may be 0.5, 0.55, 0.6, 0.65, 0.7, 0.75, 0.8, 0.85, 0.9, or 0.95, and may certainly be other values in the above-mentioned range.

In the related art, stability and reliability of the connection between the photovoltaic assembly and the color steel tile are poor, and under an external force, the photovoltaic assembly easily deforms or easily slides on the color steel tile and even falls off from the color steel tile. As can be seen from the above, in some embodiments of the present disclosure, through the arrangement of the bonding layer 3 on the angle relaxation portion 11, the photovoltaic assembly 2 is bonded to the color steel tile 1 through the bonding layer 3. This design helps improve stability and reliability of mounting of the photovoltaic assembly 2 on the color steel tile 1, and at the same time, further helps improve the load resistance capability of the photovoltaic assembly 2, so that the photovoltaic assembly 2 can have relatively excellent wind resistance, thereby reducing a possibility of deformation of the photovoltaic assembly 2 or separation from the color steel tile 1 under an external force. Therefore, it helps realize normal and stable operation of the photovoltaic assembly 2, and helps improve security of use of the photovoltaic assembly 2. In actual use of the photovoltaic device, each color steel tile 1 may have a different version, and the color steel tile 1 of each version may include a different number of the angle relaxation portions 11. In some embodiments of the present disclosure, the limitation on the ratio of the projection area S of the second bonding portion 312 to the projection area T of the angle relaxation portion 11 enables the area of the second bonding portion 312 to be adjusted according to the area of the angle relaxation portion 11, so that the color steel tile 1 of any version can have an appropriate bonding area to meet bonding requirements of the photovoltaic assembly 2. This design helps improve the bonding effect of the bonding layer 3, thereby helping improve stability and reliability of the connection between the photovoltaic assembly 2 and the color steel tile 1. At the same time, this design also helps keep a total area of the second bonding portion 312 within a reasonable range, thereby helping save a usage amount of the second bonding portion 312, reducing a possibility of a waste of adhesives due to an excessively large total area of the second bonding portion 312, and helping reduce mounting and use costs of the photovoltaic device. Further, this also helps reduce an overall weight of the photovoltaic device while meeting overall structural strength of the photovoltaic device, thereby helping meet mounting and use requirements of the photovoltaic device.

As shown in FIG. 12, in a possible embodiment, the color steel tile 1 includes one angle relaxation portion 11, and along the length direction X of the color steel tile 1, the second bonding portion 312 may have a same length as the angle relaxation portion 11. The ratio of the projection area S of the second bonding portion 312 to the projection area T of the top wall 11a of the angle relaxation portion 11 ranges from 0.5 to 0.95. This design helps improve the bonding effect of the second bonding portion 312, thereby helping improve stability and reliability of bonding of the photovoltaic assembly 2.

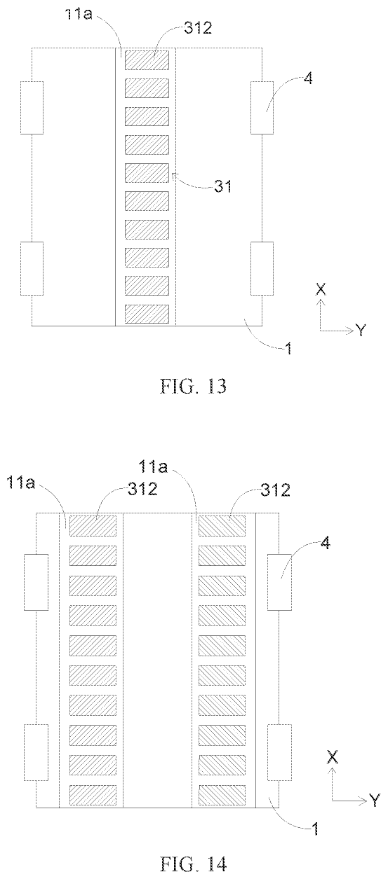

As shown in FIG. 13, in a possible embodiment, the color steel tile 1 includes one angle relaxation portion 11, and the bonding layer 3 includes a plurality of bonding parts 31 arranged at intervals along the length direction X of the color steel tile 1. The bonding part 31 at least includes one first bonding portion 311 (not shown) and one second bonding portion 312. Along the height direction Z of the color steel tile 1, a ratio of a projection area of the second bonding portion 312 of one bonding part 31 to a projection area of the top wall 11a of the angle relaxation portion 11 is less than or equal to 0.2.

In this embodiment, the color steel tile 1 includes one angle relaxation portion 11, and on the top wall 11a of the angle relaxation portion 11, the plurality of bonding parts 31 are arranged at intervals. For example, the plurality of bonding parts 31 may be evenly arranged on the angle relaxation portion 11. That is, spacing distances between two adjacent bonding parts 31 are the same. Or, the plurality of bonding parts 31 may be unevenly arranged on the angle relaxation portion 11. For example, the spacing distances between adjacent bonding parts 31 may gradually increase or gradually decrease along a direction towards an edge of the angle relaxation portion 11. For example, the ratio of the projection area of the second bonding portion 312 of one bonding part 31 to the projection area of the top wall 11a of the angle relaxation portion 11 may be 0.01, 0.02, 0.04, 0.06, 0.08, 0.1, 0.12, 0.14, 0.16, 0.18, or 0.2, and may certainly be other values in the above-mentioned range.

This design helps realize reasonable arrangement of the second bonding portions 312 on the angle relaxation portion 11, thereby helping improve the bonding effect of the second bonding portion 312 and helping improve stability and accuracy of the connection between the photovoltaic assembly 2 and the color steel tile 1. At the same time, this design further helps improve the load resistance capability of the photovoltaic assembly 2, enabling the photovoltaic assembly 2 to have excellent wind resistance. Further, through the limitation on the ratio of the area of the second bonding portion 312 to the area of the top wall 11a of all the angle relaxation portion 11, a bonding area of the second bonding portion 312 of the bonding part 31 is kept within a reasonable range, so that the second bonding portion 312 provides the photovoltaic assembly 2 with a stable and reliable bonding effect. At the same time, it is also conducive to saving a usage amount of the adhesive, thereby helping reduce mounting costs of the photovoltaic device.

As shown in FIG. 14 to FIG. 16, in a possible embodiment, the color steel tile 1 includes two angle relaxation portions 11, the two angle relaxation portions 11 are arranged along the width direction Y of the color steel tile 1. Each of the two angle relaxation portions 11 are each provided with the bonding layer 3, and along the height direction Z of the color steel tile 1, a total projection area of the second bonding portion 312 on one of the two angle relaxation portions 11 is the same as that of the second bonding portion 312 on the other one of the two angle relaxation portions 11.

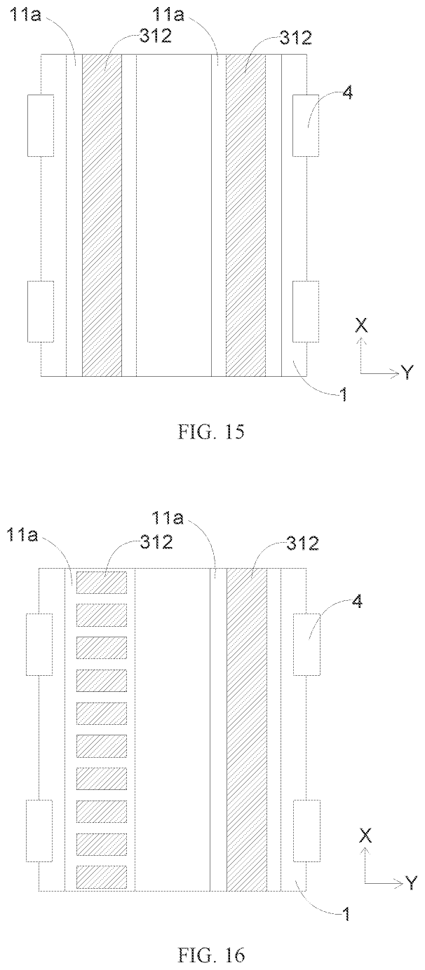

The second bonding portions 312 on the two angle relaxation portions 11 may be arranged in a same manner or in different manners. For example, as shown in FIG. 14, the second bonding portions 312 on each of the two angle relaxation portions 11 are arranged at intervals; or as shown in FIG. 15, the second bonding portion 312 on each of the two angle relaxation portions 11 is a continuous structure; or as shown in FIG. 16, the second bonding portion 312 on one of the two angle relaxation portions 11 is a continuous structure, while the second bonding portions 312 on the other one of the two angle relaxation portions 11 are arranged at intervals. A ratio of the total projection area of the second bonding portion 312 on one of the angle relaxation portions 11 to the total projection area of the second bonding portion 312 on the other one of the angle relaxation portions 11 is 1:1.

This design helps improve evenness of the arrangement of the second bonding portions 312 on the color steel tile 1, and enables the areas of the second bonding portions 312 on the two angle relaxation portions 11 to be kept within a reasonable range, which reduces a possibility of unstable bonding of the photovoltaic assembly 2 caused by an excessively large difference between the areas of the second bonding portions 312 on the two angle relaxation portions 11, thereby helping improve stability of mounting of the photovoltaic assembly 2 on the color steel tile 1, and at the same time, helping improve wind resistance of the photovoltaic assembly 2 and reducing a possibility of deformation of the photovoltaic assembly 2 or fall-off from the color steel tile 1 under an external force.

In a possible embodiment, along the height direction Z of the color steel tile 1, for either of the angle relaxation portions 11, a ratio of the total projection area of the second bonding portion 312 to a projection area of the top wall 11a of the angle relaxation portion 11 corresponding thereto is less than or equal to 0.2.

In some embodiments, the color steel tile 1 may include two angle relaxation portions 11. A ratio of the projection area of the second bonding portion 312 on each of the two angle relaxation portions 11 to the projection area of the top wall 11a of the angle relaxation portion 11 may be 0.01, 0.02, 0.05, 0.07, 0.09, 0.1, 0.13, 0.17, 0.18, 0.19, or 0.2, and may certainly be other values in the above-mentioned range.

This design helps improve the bonding effect of the second bonding portion 312, thereby helping improve stability and reliability of the connection between the photovoltaic assembly 2 and the color steel tile 1. At the same time, the limitation on the area of the second bonding portion 312 enables the area to be kept within a reasonable range, which helps save a usage amount of the second bonding portion 312, thereby helping reduce mounting costs of the photovoltaic device, and reduces a possibility of a waste caused by an excessively large usage amount of the second bonding portion 312.

As shown in FIG. 14, in a possible embodiment, the color steel tile 1 may include two angle relaxation portions 11. Each of the two angle relaxation portions 11 is provided with a plurality of second bonding portions 312 arranged at intervals. For example, the plurality of second bonding portions 312 may be evenly arranged on the angle relaxation portion 11. That is, spacing distances between two adjacent second bonding portions 312 are the same. Or, the plurality of second bonding portions 312 may be unevenly arranged on the angle relaxation portion 11. For example, the spacing distances between the second bonding portions 312 may gradually increase or gradually decrease along a direction towards an edge of the angle relaxation portion 11. For one of the angle relaxation portions 11, a ratio of a projection area of one second bonding portion 312 to a projection area of the top wall 11a of the angle relaxation portion 11 is less than or equal to 0.2. For example, this ratio may be 0.01, 0.02, 0.04, 0.06, 0.08, 0.1, 0.12, 0.14, 0.16, 0.18, or 0.2, and may certainly be other values in the above-mentioned range.

The arrangement of the plurality of second bonding portions 312 at intervals on the angle relaxation portion 11 helps improve a bonding effect, thereby helping improve stability and reliability of the connection between the photovoltaic assembly 2 and the color steel tile 1, and at the same time, further helps improve the load resistance capability of the photovoltaic assembly 2, enabling the photovoltaic assembly 2 to have excellent wind resistance. Further, through the limitation on the ratio of the area of the second bonding portion 312 to the area of the top wall 11a of the corresponding angle relaxation portion 11, the bonding area of the second bonding portion 312 can be kept within a reasonable range, and the second bonding portion 312 can provide the photovoltaic assembly 2 with a stable and reliable bonding effect. At the same time, it is also conducive to saving a usage amount of the second bonding portion 312, thereby helping reduce mounting costs of the photovoltaic device.

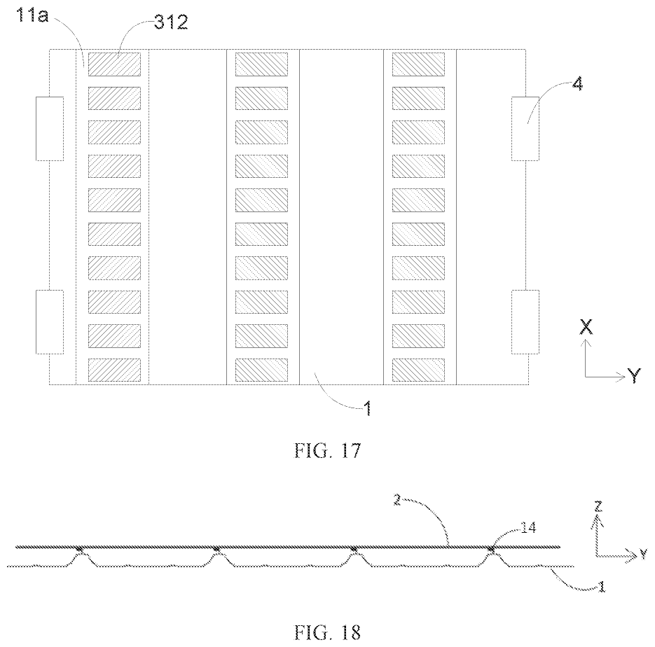

As shown in FIG. 17, in a possible embodiment, the color steel tile 1 includes a plurality of angle relaxation portions 11, the plurality of angle relaxation portions 11 are arranged along the width direction Y of the color steel tile 1. Along the height direction Z of the color steel tile 1, a ratio of a total projection area of the second bonding portion 312 on one of the angle relaxation portions 11 to a projection of the top wall 11a of the angle relaxation portion 11 is less than or equal to 0.2.

In this embodiment, a number of the angle relaxation portion 11 may be three, four, or more. For example, a ratio of the total projection area of the second bonding portion 312 on one of the angle relaxation portions 11 to the projection area of the top wall 11a of the angle relaxation portion 11 may be 0.01, 0.02, 0.05, 0.07, 0.09, 0.1, 0.13, 0.17, 0.18, 0.19, or 0.2, and may certainly be other values in the above-mentioned range.

This design helps improve an overall bonding effect of the second bonding portion 312, thereby helping improve stability and reliability of the connection between the photovoltaic assembly 2 and the color steel tile 1. At the same time, the limitation on the area of the second bonding portion 312 enables the area to be kept within a reasonable range, which helps save a usage amount of the second bonding portion 312, thereby helping reduce mounting costs of the photovoltaic device, and reduces a possibility of a waste caused by an excessively large usage amount of the second bonding portion 312.

As shown in FIG. 17, in a possible embodiment, the color steel tile 1 includes a plurality of angle relaxation portions 11. Each of the angle relaxation portions 11 may be provided with a plurality of second bonding portions 312 arranged at intervals. For example, a ratio of a projection area of one second bonding portion 312 to a projection area of the top wall 11a of the angle relaxation portion 11 corresponding thereto may be 0.01, 0.02, 0.03, 0.04, 0.05, 0.06, 0.07, 0.08, 0.09, or 0.1, and may certainly be other values in the above-mentioned range. The second bonding portions 312 on the each angle relaxation portion 11 may be arranged in a same manner or in different manners.

For the color steel tile 1 including a plurality of angle relaxation portions 11, this design helps improve stability and reliability of the connection between the photovoltaic assembly 2 and the color steel tile 1, and helps further save a usage amount of the second bonding portion 312, to reduce mounting costs of the photovoltaic device. The limitation on the area of the second bonding portion 312 enables the area to be kept within a reasonable range, which helps further improve the bonding effect of the photovoltaic assembly 2.

As shown in FIG. 17, in a possible embodiment, the color steel tile 1 includes a plurality of angle relaxation portions 11. For each of the angle relaxation portions 11, a total projection area of the second bonding portions 312 along the height direction Z of the color steel tile 1 are the same. This design helps improve evenness of the arrangement of the second bonding portions 312 on the color steel tile 1, thereby helping improve stability of bonding of the photovoltaic assembly 2, which reduces a possibility of unstable bonding caused by an excessively large difference between the areas of the second bonding portions 312 on the plurality of angle relaxation portions 11, further improves the wind resistance of the photovoltaic assembly 2, and reduces a possibility of deformation of the photovoltaic assembly 2 or fall-off from the color steel tile 1 under an external force.

As shown in FIG. 18, the color steel tile 1 includes an overlock structure 14. The overlock structure 14 may have a bonding platform extending along the width direction Y of the color steel tile 1. The above-mentioned bonding layer 3 is arranged on the bonding platform, to realize the connection between the photovoltaic assembly 2 and the color steel tile 1.

As shown in FIG. 1 and FIG. 2, in a second aspect of some embodiments of the present disclosure, a method for mounting a photovoltaic device is provided. The photovoltaic device includes a color steel tile 1 and a photovoltaic assembly 2. The method for mounting a photovoltaic device includes the following steps.

In S1, a first bonding portion 311 is provided on an angle relaxation portion 11 of the color steel tile 1.

In S2, a second bonding portion 312 with a curing speed lower than that of the first bonding portion 311 is provided on the angle relaxation portion 11, the second bonding portion 312 and the first bonding portion 311 being arranged along a first direction.

In the first direction, a ratio of a dimension W11 of the first bonding portion 311 to a dimension W12 of the second bonding portion 312 satisfies: 0.1 to 0.5.

The first bonding portion 311 may be a solid adhesive. For example, the first bonding portion 311 may be a double-sided adhesive tape. A base material of the adhesive tape may be sponge, foam, tissue paper, a polypropylene film, a polyvinyl chloride film, fiber cloth, fiber plastic, or other materials. The second bonding portion 312 may be a structural adhesive. The structural adhesive may be an adhesive such as a polycarbonate adhesive, an epoxy resin adhesive, a silicone adhesive, an acrylic adhesive, or a polyurethane adhesive. For example, the second bonding portion 312 may be one of the above-mentioned adhesives, or the second bonding portion 312 may be a combination of the above-mentioned adhesives. In step S1, the first bonding portion 311 may be arranged on the angle relaxation portion 11 by means of a taping machine. In step S2, the second bonding portion 312 may be arranged on the angle relaxation portion 11 by means of a gluing apparatus. In some embodiments of the present disclosure, the first bonding portion 311 and the second bonding portion 312 are two different adhesives, and have different curing speeds. The curing speed of the first bonding portion 311 may be higher than that of the second bonding portion 312. Due to the difference in the curing speeds, the first bonding portion 311 and the second bonding portion 312 can exhibit different fluidities during use. For example, the first bonding portion 311 may be an adhesive that has a relatively high degree of curing or has been cured, which has low fluidity or no fluidity when arranged on the angle relaxation portion 11. Since the curing speed of the second bonding portion 312 is relatively low, the second bonding portion 312 still has strong fluidity for a certain period of time after being arranged on the angle relaxation portion 11. Since the first bonding portion 311 is featured with a high degree of curing and a low flowing property, during mounting of the photovoltaic assembly 2, the first bonding portion 311 may immediately bond the photovoltaic assembly 2. That is, the first bonding portion 311 may temporarily fix and position the photovoltaic assembly 2, thereby reducing a possibility of sliding and deviation of the photovoltaic assembly 2 on the color steel tile 1, so that the photovoltaic assembly 2 can be stably placed at a preset mounting position, to improve accuracy of mounting of the photovoltaic assembly 2. Further, since the first bonding portion 311 can also provide certain bonding strength for the photovoltaic assembly 2, the arrangement of the first bonding portion 311 also helps improve stability of bonding of the photovoltaic assembly 2. The second bonding portion 312 plays a major role in bonding and fixing the photovoltaic assembly 2. Since the second bonding portion 312 is featured with a low curing speed, the second bonding portion 312 can flow on the angle relaxation portion 11 after gluing. Therefore, the second bonding portion 312 can fully flow and fill a gap between the angle relaxation portion 11 and the photovoltaic assembly 2, thereby reducing a possibility of an unbonded portion between the photovoltaic assembly 2 and the angle relaxation portion 11. Therefore, the arrangement of the second bonding portion 312 helps improve uniformity, stability, and reliability of bonding of the photovoltaic assembly 2, and at the same time, also helps increase an overall bonding area of the photovoltaic assembly 2.

In the related art, stability of mounting of the photovoltaic assembly on the color steel tile is poor, and under an external force, the photovoltaic assembly is easily deformed or easily detached from the color steel tile. As a result, the photovoltaic device cannot be used normally. In some embodiments of the present disclosure, the photovoltaic assembly 2 is connected to the color steel tile 1 through the first bonding portion 311 and the second bonding portion 312. This design helps improve stability and reliability of mounting of the photovoltaic assembly 2, and also helps improve the load resistance capability of the photovoltaic assembly 2, so that the photovoltaic assembly 2 has relatively excellent wind resistance, which reduces a possibility of deformation of the photovoltaic assembly 2, shaking of the photovoltaic assembly 2 on the color steel tile 1, or detachment of the photovoltaic assembly 2 from the color steel tile 1 under an external force. In addition, under an action of the first bonding portion 311, it is conducive to improving accuracy of mounting of the photovoltaic assembly 2, so that the photovoltaic assembly 2 can be accurately mounted to a preset mounting position, thereby helping increase the success rate of mounting of the photovoltaic assembly 2.

In the related art, the photovoltaic assembly is generally bonded with the color steel tile by using the structural adhesive. However, the structural adhesive has a low curing speed, and the uncured structural adhesive has poor bonding performance. Therefore, the photovoltaic assembly is prone to deviation during a wait for curing of the structural adhesive, resulting in an inaccurate mounting position or fall-off from the color steel tile 1. In some embodiments of the present disclosure, the first bonding portion 311 and the second bonding portion 312 are simultaneously used to bond the photovoltaic assembly 2, the first bonding portion 311 can play a temporary fixing role to improve accuracy of mounting of the photovoltaic assembly 2, and the second bonding portion 312 plays a main fixing role to improve stability of mounting of the photovoltaic assembly 2. Therefore, under a joint action of the first bonding portion 311 and the second bonding portion 312, it is conducive to stable, reliable, and accurate mounting of the photovoltaic assembly 2, thereby helping realize normal operation of the photovoltaic assembly 2.

The first direction may be parallel to the width direction Y of the color steel tile 1, or may be parallel to the length direction X of the color steel tile 1. That is, the first bonding portion 311 and the second bonding portion 312 may be arranged along the width direction Y of the color steel tile 1, or may be arranged along the length direction X of the color steel tile 1.

In the first direction, a ratio of the dimension of the first bonding portion 311 to the dimension of the second bonding portion 312 may be 0.1, 0.15, 0.2, 0.25, 0.3, 0.35, 0.4, 0.45, or 0.5, and may certainly be other values in the above-mentioned range. If the ratio of the dimension of the first bonding portion 311 to the dimension of the second bonding portion 312 is excessively small, that is, the dimension of the first bonding portion 311 is smaller or the dimension of the second bonding portion 312 is larger, it is easy to reduce reliability of the first bonding portion 311 and affect a bonding effect of the first bonding portion 311. As a result, the photovoltaic assembly 2 is prone to sliding and deviation on the color steel tile 1, thereby affecting accuracy of mounting of the photovoltaic assembly 2. If the ratio of the dimension of the first bonding portion 311 to the dimension of the second bonding portion 312 is excessively large, that is, the dimension of the first bonding portion 311 is larger or the dimension of the second bonding portion 312 is smaller, it is easy to reduce reliability of the second bonding portion 312 and affect the bonding effect of the second bonding portion 312. As a result, it is difficult for the photovoltaic assembly 2 to be stably connected to the color steel tile 1, and the photovoltaic assembly 2 is easy to fall off from the color steel tile 1 under an external force, thereby affecting stability and reliability of mounting of the photovoltaic assembly 2. Therefore, in some embodiments of the present disclosure, the ratio of the dimension of the first bonding portion 311 to the dimension of the second bonding portion 312 is limited to keep the respective dimensions within a reasonable range, thereby helping improve respective bonding performance of the first bonding portion 311 and the second bonding portion 312, improving stability and accuracy of mounting of the photovoltaic assembly 2, and helping improve a load resistance capability of the photovoltaic assembly 2, to improve wind resistance of the photovoltaic assembly 2.

In order to improve stability of the arrangement of the first bonding portion 311 and the second bonding portion 312 on the top wall 11a of the angle relaxation portion 11 and improve bonding effects of the first bonding portion 311 and the second bonding portion 312, before applying an adhesive to the angle relaxation portion 11, the method for mounting a photovoltaic device further includes: cleaning a surface of the color steel tile 1. For example, the surface of the color steel tile 1 may be cleaned by using a cleaning fluid. The cleaning fluid may be water, ethanol, or acetone. Certainly, other materials that meet a cleaning effect of the color steel tile 1 can also be used. After the surface of the color steel tile 1 is cleaned, the surface of the color steel tile 1 may also be dried, to ensure that the surface of the color steel tile 1 is in a dry state. After the surface of the color steel tile 1 is cleaned, the method for mounting a photovoltaic device further includes: providing a primer on the top wall 11a of the angle relaxation portion 11 of the color steel tile 1. Before the first bonding portion 311 and the second bonding portion 312 are provided, a primer may be applied to the top wall 11a of the angle relaxation portion 11. The application of the primer helps improve bonding performance of the first bonding portion 311 and the second bonding portion 312, thereby helping improve stability of bonding of the photovoltaic assembly 2.

In a possible embodiment, prior to the providing, on the angle relaxation portion 11, a second bonding portion 312 with a curing speed lower than that of the first bonding portion 311, the method for mounting a photovoltaic device further includes the following step.

In S3, the photovoltaic assembly 2 abuts against the first bonding portion 311 along the height direction Z of the color steel tile 1.

In some embodiments, the first bonding portion 311 is provided on the angle relaxation portion 11, then the photovoltaic assembly 2 is mounted on the color steel tile 1, and after the photovoltaic assembly 2 is connected to the first bonding portion 311, the second bonding portion 312 is provided on the angle relaxation portion 11. In this process, the first bonding portion 311 plays a role in temporarily fixing the photovoltaic assembly 2. That is, under the bonding effect of the first bonding portion 311, the photovoltaic assembly 2 can be maintained at a preset mounting position relatively stably, which reduces a possibility of deviation and sliding of the photovoltaic assembly 2 or fall-off from the color steel tile 1, to improve accuracy of mounting of the photovoltaic assembly 2. After the photovoltaic assembly 2 is connected to the color steel tile 1, the second bonding portion 312 can be provided between the angle relaxation portion 11 and the photovoltaic assembly 2. Due to relatively good fluidity when not cured, the second bonding portion 312 can quickly fill the gap between the angle relaxation portion 11 and the photovoltaic assembly 2. As the degree of curing of the second bonding portion 312 becomes higher and higher, bonding performance thereof is also gradually enhanced. The second bonding portion 312 can firmly bond the photovoltaic assembly 2 to the color steel tile 1 to improve stability and reliability of mounting of the photovoltaic assembly 2. Under a joint action of the first bonding portion 311 and the second bonding portion 312, it is also conducive to improving the load resistance capability of the photovoltaic assembly 2, thereby helping realize normal and stable operation of the photovoltaic assembly 2.

In a possible embodiment, subsequent to the providing, on the angle relaxation portion 11, a second bonding portion 312 with a curing speed lower than that of the first bonding portion 311, the method for mounting a photovoltaic device includes the following steps.

In S4, the photovoltaic assembly 2 abuts against the first bonding portion 311 and the second bonding portion 312 along the height direction Z of the color steel tile 1.

In some embodiments, the first bonding portion 311 is provided on the angle relaxation portion 11, then the second bonding portion 312 is provided on the angle relaxation portion 11, and after both the first bonding portion 311 and the second bonding portion 312 are provided, the photovoltaic assembly 2 is mounted on the color steel tile 1. In this process, the first bonding portion 311 and the second bonding portion 312 simultaneously play a corresponding role in the photovoltaic assembly 2. The first bonding portion 311 plays a role in temporarily fixing the photovoltaic assembly 2, enabling the photovoltaic assembly 2 to be maintained at a preset mounting position relatively stably, to improve accuracy of mounting of the photovoltaic assembly 2. The second bonding portion 312 can firmly bond the photovoltaic assembly 2 to the color steel tile 1, to improve stability and reliability of mounting of the photovoltaic assembly 2. In these embodiments, it is conducive to improving convenience of gluing and making it easier for an operator to operate, and at the same time, is also conducive to reducing a possibility of damage to the photovoltaic assembly 2 due to collision of respective gluing apparatuses of the first bonding portion 311 and the second bonding portion 312 with the photovoltaic assembly 2, thereby prolonging a service life of the photovoltaic assembly 2.

As shown in FIG. 2, in a possible embodiment, the method for mounting a photovoltaic device includes the following steps.

In S5, the second bonding portion 312 is provided on one side of the first bonding portion 311 along the width direction Y of the color steel tile 1; and along the length direction X of the color steel tile 1, dimensions of the first bonding portion 311, the second bonding portion 312, and the angle relaxation portion 11 are the same.

In some embodiments, the first bonding portion 311 and the second bonding portion 312 are arranged along the width direction Y of the color steel tile 1, and each of the first bonding portion 311 and the second bonding portion 312 has a same length as the angle relaxation portion 11. This design helps increase bonding areas of the first bonding portion 311 and the second bonding portion 312, thereby helping improve bonding effects of the first bonding portion 311 and the second bonding portion 312, helping improve accuracy, stability, and reliability of mounting of the photovoltaic assembly 2, and also helping improve the load resistance capability of the photovoltaic assembly 2.

In other possible embodiments, along the length direction X of the color steel tile 1, the dimension of one of the first bonding portion 311 and the second bonding portion 312 may be smaller than the dimension of the angle relaxation portion 11, and the dimensions of the first bonding portion 311 and the second bonding portion 312 are different from each other. The dimension of the first bonding portion 311 may be larger than that of the second bonding portion 312 or may be smaller than that of the second bonding portion 312.

As shown in FIG. 6, in a possible embodiment, the photovoltaic device further includes a bonding part 31. The bonding part 31 includes a first bonding portion 311 and a second bonding portion 312. The method for mounting a photovoltaic device includes the following steps.

In S6, the second bonding portion 312 is provided at one side of the first bonding portion 311 along the width direction Y of the color steel tile 1.

In S7, a plurality of bonding parts 31 are arranged at intervals on the angle relaxation portion 11 along the length direction X of the color steel tile 1.

In some embodiments, the first bonding portion 311 and the second bonding portion 312 of the bonding part 31 are arranged along the width direction Y of the color steel tile 1. Along the length direction X of the color steel tile 1, dimensions of the first bonding portion 311 and the second bonding portion 312 may be the same or different from each other. A plurality of bonding parts 31 are arranged at intervals on the angle relaxation portion 11. Along the length direction X of the color steel tile 1, a dimension L1 of one bonding part 3 satisfies: 100 nm to 400 nm. For example, L1 may be 100 mm, 140 mm, 180 mm, 220 mm, 260 mm, 300 mm, 340 mm, 380 mm, or 400 mm, and may certainly be other values in the above-mentioned range. A spacing distance D1 between two adjacent bonding parts 3 satisfies: 0<D1≤200 mm. For example, D1 may be 0.05 mm, 0.2 mm, 0.8 mm, 1.2 mm, 5 mm, 8 mm, 15 mm, 25 mm, 45 mm, 65 mm, 75 mm, 85 mm, 100 mm, 125 mm, 150 mm, 175 mm, 190 mm, or 200 mm, and may certainly be other values in the above-mentioned range.

The arrangement of the plurality of bonding parts 31 at intervals on the angle relaxation portion 11 helps improve stability, reliability, and accuracy of mounting of the photovoltaic assembly 2. Moreover, this design further helps save usage amounts of the first bonding portions 311 and the second bonding portions 312, thereby helping reduce mounting costs of the photovoltaic device, and helps reduce a weight of the photovoltaic device, thereby facilitating mounting and use of the photovoltaic device. The limitations on the dimension L1 of the bonding part 31 and the spacing distance D1 help realize a reasonable arrangement of the bonding parts 31 on the angle relaxation portion 11, thereby further helping improve bonding effects of the first bonding portions 311 and the second bonding portions 312.

As shown in FIG. 8 to FIG. 10, in a possible embodiment, the method for mounting a photovoltaic device includes the following step.

In S8, the first bonding portions 311 and the second bonding portions 312 are alternately arranged along the length direction X of the color steel tile 1.

In some embodiments, a plurality of first bonding portions 311 and a plurality of second bonding portions 312 are provided, and are alternately arranged along the length direction X of the color steel tile 1. This design helps improve evenness of the arrangement of the first bonding portions 311 and the second bonding portions 312 on the angle relaxation portion 11, thereby helping improve stability of bonding of the photovoltaic assembly 2 and helping improve a wind resistance capability of the photovoltaic assembly 2.

As shown in FIG. 8, in a possible embodiment, the method for mounting a photovoltaic device includes the following step.

In S9, the first bonding portions 311 and the second bonding portions 312 are alternately arranged in a continuous manner along the length direction X of the color steel tile 1.

In some embodiments, any two adjacent first bonding portions 311 and second bonding portions 312 are connected together. Along the length direction X of the color steel tile 1, a sum L2 of dimensions of all the first bonding portions 311 and all the second bonding portions 312 may be smaller than the dimension L3 of the angle relaxation portion 11. For example, a ratio of the dimension L2 to the dimension L3 may be 0.05 to 0.2. The ratio may be 0.05, 0.07, 0.09, 0.1, 0.12, 0.14, 0.16, 0.18, or 0.2, and may certainly be other values in the above-mentioned range.

This design helps improve stability of bonding of the photovoltaic assembly 2. The limitation on an overall dimension of the first bonding portions 311 and the second bonding portions 312 enables the overall dimension to be kept within a reasonable range, thereby further improving bonding performance thereof, and further improving accuracy, stability, and reliability of mounting of the photovoltaic assembly 2.

In other possible embodiments, the sum L2 of the dimensions of all the first bonding portions 311 and all the second bonding portions 312 may be the same as the dimension L3 of the angle relaxation portion 11.

As shown in FIG. 9, in a possible embodiment, the method for mounting a photovoltaic device includes the following step.

In S10, any two adjacent ones of the first bonding portions 311 and second bonding portions 312 are arranged at an interval.

According to a bonding requirement of the photovoltaic assembly 2 in actual mounting, the first bonding portions 311 and the second bonding portions 312 may be evenly arranged on the angle relaxation portion 11. That is, spacing distances between any two adjacent ones of the first bonding portions 311 and any second bonding portions 312 are the same. Or, the first bonding portions 311 and the second bonding portions 312 may be unevenly arranged on the angle relaxation portion 11. For example, the spacing distances between the first bonding portions 311 and the second bonding portions 312 may gradually increase or gradually decrease along a direction towards an edge of the angle relaxation portion 11.

This design helps realize a reasonable arrangement of the first bonding portions 311 and the second bonding portions 312 on the top wall 11a of the angle relaxation portion 11, thereby helping improve bonding effects of the first bonding portions 311 and the second bonding portions 312. At the same time, this design also helps save usage amounts of the first bonding portions 311 and the second bonding portions 312, thereby helping reduce mounting costs of the photovoltaic device, and helps reduce a weight of the photovoltaic device, thereby facilitating mounting and use of the photovoltaic device.

As shown in FIG. 10, in a possible embodiment, the photovoltaic device further includes a bonding part 31. The bonding part 31 includes a first bonding portion 311 and a second bonding portion 312. The first bonding portion 311 is connected to the second bonding portion 312. The method for mounting a photovoltaic device includes the following step.

In S11, a plurality of bonding parts 31 are arranged at intervals on the angle relaxation portion 11 along the length direction X of the color steel tile 1.

In some embodiments, the first bonding portion 311 and the second bonding portion 312 of the bonding part 31 are arranged in a continuous manner (that is, the first bonding portion 311 and the second bonding portion 312 are connected together). A plurality of bonding parts 31 are arranged at intervals on the angle relaxation portion 11, and a spacing distance D2 between two adjacent bonding parts 31 satisfies: 0<D2≤200 mm. For example, the spacing distance D2 between two adjacent bonding portions 3 may be 0.1 mm, 0.5 mm, 1 mm, 10 mm, 20 mm, 40 mm, 60 mm, 80 mm, 100 mm, 120 mm, 140 mm, 160 mm, 180 mm, or 200 mm, and may certainly be other values in the above-mentioned range.

This design helps realize reasonable arrangement of the first bonding portion 311 and the second bonding portion 312 on the top wall 11a of the angle relaxation portion 11, thereby helping improve bonding effects of the first bonding portion 311 and the second bonding portion 312, to improve accuracy, stability, and reliability of mounting of the photovoltaic assembly 2 and also improve the load resistance capability of the photovoltaic assembly 2, so that the photovoltaic assembly 2 can have relatively excellent wind resistance, thereby helping realize normal and stable operation of the photovoltaic assembly 2.

As shown in FIG. 1 and FIG. 11, in a possible embodiment, the method for mounting a photovoltaic device further includes the following steps.

In S12, a male rib 12 of one of the color steel tiles 1 and a female rib 13 of another one of the color steel tiles 1 adjacent thereto are clamped by using a clamp 4.

In S13, the photovoltaic assembly 2 is connected to the clamp 4.

In some embodiments, the male rib 12 and the female rib 13 at two sides of the color steel tile 1 may be clamped by the clamp 4. For example, the photovoltaic device may include a plurality of color steel tiles 1. In two adjacent color steel tiles 1, the male rib 12 of one color steel tile 1 may be connected to the female rib 13 of the other one color steel tile 1 to form an overlock structure, and the overlock structure may be clamped by using the clamp 4, so as to achieve a connection with the two color steel tiles 1. The photovoltaic device may include a plurality of clamps 4. The arrangement of the plurality of clamps 4 helps improve stability of mounting of the photovoltaic assembly 2. After the photovoltaic assembly 2 is connected to the first bonding portion 311 and the second bonding portion 312, the photovoltaic assembly 2 can be connected to the clamp 4. According to this design, the photovoltaic assembly 2 can be connected to the color steel tile 1 through the clamp 4 while being bonded to the color steel tile 1, and under the action of the first bonding portion 311, the second bonding portion 312, and the clamp 4, stability and reliability of mounting of the photovoltaic assembly 2 are further improved. At the same time, wind resistance of the photovoltaic assembly 2 is further improved, which reduces a possibility of deformation of the photovoltaic assembly 2 or detachment from the color steel tile 1 under an external force, thereby helping realize normal and stable operation of the photovoltaic assembly 2.

Some embodiments of the present disclosure provide a photovoltaic device and a method for mounting a photovoltaic device, including a color steel tile, a bonding layer, and a photovoltaic assembly. The color steel tile includes at least one angle relaxation portion. The bonding layer is arranged on a top wall of the angle relaxation portion. The photovoltaic assembly is located on one side of the color steel tile and connected to the color steel tile through the bonding layer. The bonding layer includes a first bonding portion and a second bonding portion arranged along a first direction. In the first direction, a ratio of a dimension of the first bonding portion to a dimension of the second bonding portion ranges from 0.1 to 0.5. The first bonding portion can play a temporary fixing role to improve accuracy of mounting of the photovoltaic assembly. The second bonding portion plays a main fixing role to improve stability of mounting of the photovoltaic assembly. Under a joint action of the first bonding portion and the second bonding portion, it is conducive to stable, reliable, and accurate mounting of the photovoltaic assembly, thereby helping realize normal operation of the photovoltaic assembly. The ratio of the dimension of the first bonding portion to the dimension of the second bonding portion is limited to keep the respective dimensions within a reasonable range, thereby helping improve respective bonding performance of the first bonding portion and the second bonding portion, improving stability and accuracy of mounting of the photovoltaic assembly, and helping improve a load resistance capability of the photovoltaic assembly, to improve wind resistance of the photovoltaic assembly.

The above are merely preferred embodiments of the present disclosure and are not intended to limit the present disclosure. For those skilled in the art, the present disclosure may be subject to various changes and variations. Any modification, equivalent replacement, improvement, and the like made within the spirit and principles of the present disclosure shall fall within the protection scope of the present disclosure.

What is claimed is:

1. A photovoltaic device, comprising:
a color steel tile comprising at least one angle relaxation portion;
a bonding layer arranged on a top wall of the angle relaxation portion; and
a photovoltaic assembly arranged on one side of the color steel tile and connected to the color steel tile through the bonding layer,
wherein the bonding layer comprises a first bonding portion and a second bonding portion arranged along a first direction; and in the first direction, a ratio of a dimension of the first bonding portion to a dimension of the second bonding portion ranges from 0.1 to 0.5.

2. The photovoltaic device according to claim 1, wherein, in the first direction, the first bonding portion and the second bonding portion form a continuous structure.

3. The photovoltaic device according to claim 1, wherein, in the first direction, the first bonding portion and the second bonding portion are arranged at an interval.

4. The photovoltaic device according to claim 1, wherein, in the first direction, the first bonding portion and the second bonding portion are arranged alternately.

5. The photovoltaic device according to claim 1, wherein the first direction is parallel to a width direction of the color steel tile.

6. The photovoltaic device according to claim 5, wherein the color steel tile comprises two angle relaxation portions;
the two angle relaxation portions are arranged along the width direction of the color steel tile, and each of the two angle relaxation portions is provided with the bonding layer;
the first bonding portions of the two angle relaxation portions are arranged at a position where the two angle relaxation portions are close to each other; and
the second bonding portions of the two angle relaxation portions are arranged at positions where the two angle relaxation portions are away from each other.

7. The photovoltaic device according to claim 1, wherein the first direction is parallel to a length direction of the color steel tile.

8. The photovoltaic device according to claim 1, wherein, along the length direction of the color steel tile, a dimension of the bonding layer is the same as a dimension of the angle relaxation portion, or the dimension of the bonding layer is smaller than the dimension of the angle relaxation portion.

9. The photovoltaic device according to claim 1, wherein the bonding layer comprises a plurality of bonding parts arranged at intervals along a length direction of the color steel tile, and one of the plurality of bonding parts at least comprises one first bonding portion and one second bonding portion.

10. The photovoltaic device according to claim 9, wherein, along the length direction of the color steel tile, a spacing distance between two adjacent bonding parts satisfies: 0<D≤200 mm.

11. The photovoltaic device according to claim 9, wherein, along the length direction of the color steel tile, a dimension of one of the plurality of bonding parts ranges from 100 mm to 400 mm.

12. The photovoltaic device according to claim 1, wherein, along a height direction of the color steel tile, a dimension of the bonding layer ranges from 1 mm to 4 mm.

13. The photovoltaic device according to claim 1, wherein each of the first bonding portion and the second bonding portion extends along a second direction that intersects with the first direction; and
in the second direction, a dimension of the first bonding portion is different from a dimension of the second bonding portion.

14. The photovoltaic device according to claim 1, wherein, along a height direction of the color steel tile, a projection area of the top walls of all of the at least one angle relaxation portion on the color steel tile is T, and a projection area of the second bonding portions arranged on the bonding layers of all of the at least one angle relaxation portion is S, where a ratio of S to T ranges from 0.5 to 0.95.

15. The photovoltaic device according to claim 14, wherein the color steel tile comprises one angle relaxation portion;
the bonding layer comprises a plurality of bonding parts arranged at intervals along a length direction of the color steel tile;
one of the plurality of bonding parts at least comprises one first bonding portion and one second bonding portion; and
along a height direction of the color steel tile, a ratio of a projection area of the second bonding portion of one of the plurality of bonding parts to a projection area of the top wall of the angle relaxation portion is less than or equal to 0.2.

16. The photovoltaic device according to claim 14, wherein the color steel tile comprises two angle relaxation portions;
the two angle relaxation portions are arranged along a width direction of the color steel tile, and each of the two angle relaxation portions is provided with the bonding layer; and
along a height direction of the color steel tile, a ratio of a total projection area of the second bonding portion on one of the two angle relaxation portions is the same as a total projection area of the second bonding portion on the other one of the two angle relaxation portions.

17. The photovoltaic device according to claim 16, wherein, along the height direction of the color steel tile, for each of the two angle relaxation portions, a ratio of the total projection area of the second bonding portion to a projection area of the top wall of the angle relaxation portion corresponding thereto is less than or equal to 0.2.

18. The photovoltaic device according to claim 1, further comprising a clamp, wherein the clamp is connected to the color steel tile, and the photovoltaic assembly is connected to the clamp.

19. A method for mounting a photovoltaic device, wherein the photovoltaic device comprises at least one color steel tile and a photovoltaic assembly, and the method comprises:
providing a first bonding portion on an angle relaxation portion of one of the at least one color steel tile; and
providing, on the angle relaxation portion, a second bonding portion with a curing speed lower than that of the first bonding portion, the second bonding portion and the first bonding portion being arranged along a first direction;
wherein, in the first direction, a ratio of a dimension of the first bonding portion to a dimension of the second bonding portion ranges from 0.1 to 0.5.

20. The method according to claim 19, further comprising:
clamping, by using a clamp, a male rib of one of the at least one color steel tile and a female rib of another one of the at least one color steel tile adjacent thereto; and
connecting the photovoltaic assembly to the clamp.
